(19) United States
(12) Patent Application Publication
(10) Pub. No.: US 2016/0328859 A1
(43) Pub. Date: Nov. 10, 2016

(54) METHOD FOR DETECTING MOVEMENT SPEED UNIFORMITY OF SCANNED TARGET IN LINE SCANNING IMAGING PROCESS

(71) Applicant: JIANGSU UNIVERSITY, Jiangsu (CN)

(72) Inventors: Xiaobo ZOU, Jiangsu (CN); Jiyong SHI, Jiangsu (CN); Jiewen ZHAO, Jiangsu (CN); Xiaowei HUANG, Jiangsu (CN); Yaodi ZHU, Jiangsu (CN); Zhihua LI, Jiangsu (CN)

(73) Assignee: Jiangsu University, Jiangsu (CN)

(21) Appl. No.: 15/105,934

(22) PCT Filed: Jun. 25, 2014
(86) PCT No.: PCT/CN2014/000622

§ 371 Date: Jun. 17, 2016

(30) Foreign Application Priority Data
Dec. 20, 2013 (CN) 201310713918.6

(51) Int. Cl. G06T 7/20; G06T 7/00; G01P 3/38

(52) U.S. Cl. CPC G06T 7/204; G01P 3/38; G06T 7/0018; G06T 2207/30241

(57) ABSTRACT

Disclosed is a method for detecting movement speed uniformity of a scanned target in a line scanning imaging process. The method comprises a first step of acquiring a scan image of a rectangular correction plate ABCD, a second step of performing data processing on a scan image A′B′C′D′ and a third step of calculating a uniformity representation value S of the movement speed of the scanned target. The uniformity of the movement speed of the scanned target can be calculated quantitatively, and the method can be used for precisely correcting a line scanning imaging system, so that high-precision image information about the scanned target is obtained, and the method can be applied to high-precision computer vision detection of the scanned target.

### FIELD OF THE INVENTION

The present invention relates to the computer imaging detection field, in particular to a method for detecting movement speed uniformity of a scanned target in a line scanning imaging process.

### BACKGROUND OF THE INVENTION

Line scanning cameras are mainly applied in industrial, medical, scientific research, and security domains for image processing. In the machine vision field, line scanning camera is a sort of special vision machine. Compared with area-array cameras, the sensor of a line scanning camera has only one row of photosensitive elements, which makes high scanning frequency and high resolution possible. The line scanning cameras is typically used in detection of continuous materials, such as metal, plastics, paper, and fiber, etc. Usually, the object to be detected is scanned continuously line by line with one or more industrial cameras while the object moves at a constant speed, so that the image information of the detected object is obtained; then, the image is processed line by line, or an area-array image consisting of multiple lines is processed, to detect the external features of the surface of the detected object.

In the line scanning imaging process, the line scanning camera needs to move in high-precision at a constant speed in relation to the scanned target; the imaging system must be calibrated accurately, in order to obtain high-quality image information. The document “Integrated Calibration Method of Line-Scan High Spectral Imaging System for Agricultural Product” (Transactions of the CSAE, p244-249, No. 14, vol. 28, 2012) has disclosed a method for calibrating scanning speed and correcting guide rail offset to ensure accuracy of imaging data. However, during calibration of scanning speed, the method calibrates the average movement speed of the scanned target within a certain time period. The average speed cannot reflect the uniformity of the movement speed of the scanned target.

In view of this, the present invention provides a method for detecting movement speed uniformity of a scanned target in a line scanning imaging process, so as to solve the above problem.

### SUMMARY OF THE INVENTION

The object of the present invention is to provide a method for detecting movement speed uniformity of a scanned target in a line scanning imaging process, so as to realize high-precision imaging of the scanned target.

To solve the above-mentioned technical problem, the present invention employs the following technical scheme:

A method for detecting movement speed uniformity of a scanned target in a line scanning imaging process, comprising the following steps:

step 1. obtaining a scan image of a rectangular correction plate ABCD;

step 2. performing data processing for a scan image A′B′C′D′; and

step 3. calculating a uniformity characterization value S of the movement speed of the scanned target.

The first step of obtaining a scan image of the rectangular correction plate ABCD is as follows:

a line segment EF is the line of left-right central symmetry of the rectangular correction plate ABCD, and line segments G₁J₁, G₂J₂, . . . , Gₙ₋₁Jₙ₋₁, and GₙJₙ are perpendicular to the line segment EF respectively and intersect with the line segment EF at H₁, H₂, . . . , Hₙ₋₁, and Hₙ respectively; in addition, line segments H₁H₂, H₂H₃, . . . , Hₙ₋₂Hₙ₋₁, and Hₙ₋₁Hₙ are equal in length; the rectangular correction plate ABCD is arranged in a scanning imaging system for line scanning, so that a scan image A′B′C′D′ of the rectangular correction plate is obtained.

The second step of performing data processing for the scan image A′B′C′D′ is as follows:

E′, F′, G′₁, G′₂, . . . , G′ₙ₋₁, G′ₙ, J′₁, J′₂, . . . , J′ₙ₋₁, J′ₙ, H′₁, H′₂, . . . , H′ₙ₋₁, and H′ₙ are the images of E, F, G₁, G₂, . . . , Gₙ₋₁, Gₙ, J₁, J₂, . . . , Jₙ₋₁, Jₙ, H₁, H₂, . . . , Hₙ₋₁, and Hₙ, which are on the correction plate ABCD, in the scan image A′B′C′D′, respectively; the lengths L_{H′H′2}, L_{H′2H′3}, . . . , L_{H′n-2H′n-1}, and L_{H′n-1H′n} of the line segments H′₁H′₂, H′₂H′₃, . . . , H′ₙ₋₂H′ₙ₋₁, and H′ₙ₋₁H′ₙ in the scan image A′B′C′D of the correction plate are extracted.

The third step of calculating a uniformity characterization value S of the movement speed of the scanned target is as follows:
first, an average value L_{avg} of the lengths of the line segments H′₁H′₂, H′₂H′₃, . . . , H′ₙ₋₂H′ₙ₋₁, and H′ₙ₋₁H′ₙ is calculated with a calculation formula

$${L}_{avg} = \frac{{\sum }_{i = 2}^{n} {L}_{{H}_{i - 1}^{′} {H}_{i}^{′}}}{n - 1} ,$$

according to the lengths L_{H′1H′2}, L_{H′2H′3}, . . . , L_{H′n-2H′n-1}, and L_{H′n-1H′n} of the line segments H′₁H′₂, H′₂H′₃, . . . , H′ₙ₋₂H′ₙ₋₁, and H′_{n-I}H′ₙ; then, a uniformity characterization value S of the movement speed of the scanned target is calculated, with a calculation formula

$$S = \sqrt{\frac{{\sum }_{i = 2}^{n} {( {L}_{{H}_{i - 1}^{′} {L}_{i}^{′}} - {L}_{avg} )}^{2}}{n - 2}} ,$$

wherein, the closer the value S is to zero, the better the uniformity of the movement speed of the scanned target is.

Beneficial effects: In the present invention, by obtaining a scan image A′B′C′D′ of the correction plate ABCD and extracting characteristic information from the scan image A′B′C′D′, the uniformity of the movement speed of the scanned target can be calculated quantitatively, the method can be used for precisely correcting a line scanning imaging system, so that high-precision image information of the scanned target is obtained.

### BRIEF DESCRIPTION OF THE DRAWINGS

FIG. 1 is a flow diagram of the present invention;

FIG. 2 is a schematic diagram of a rectangular correction plate ABCD;

FIG. 3 is a schematic diagram of a scan image A′B′C′D′ of the rectangular correction plate.

### DETAILED DESCRIPTION OF THE EMBODIMENTS

Hereunder the present invention will be described in details according to the embodiments, with reference to the accompanying drawings. However, the present invention is not limited to those embodiments. All modifications or variations made by the skilled person in the art to the structure, method or functions on the basis of those embodiments shall be deemed as falling into the protection scope of the present invention.

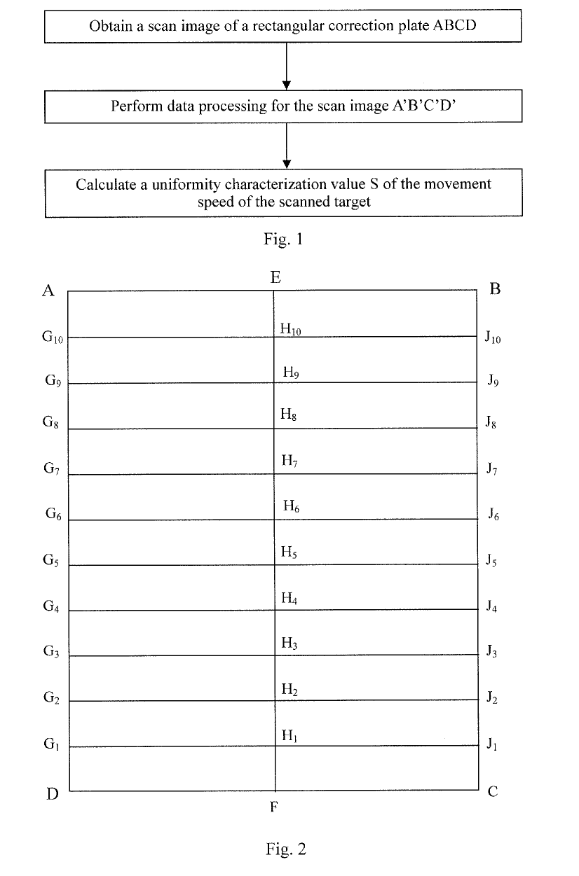

As shown in FIG. 1, the method for detecting movement speed uniformity of a scanned target in a line scanning imaging process comprises the following steps:

Step 1. obtaining a scan image of a rectangular correction plate ABCD;

step 2. performing data processing for a scan image A′B′C′D′; and

step 3. calculating a uniformity characterization value S of the movement speed of the scanned target.

The first step of obtaining a scan image of the rectangular correction plate ABCD is characterized in that: a line segment EF is the line of left-right central symmetry of the rectangular correction plate ABCD, and line segments G₁J₁, G₂J₂, . . . , Gₙ₋₁Jₙ₋₁, and GₙJₙ are perpendicular to the line segment EF respectively and intersect with the line segment EF at H₁, H₂, . . . , Hₙ₋₁, and Hₙ respectively; in addition, line segments H₁H₂, H₂H₃, . . . , Hₙ₋₂Hₙ₋₁, and Hₙ₋₁,Hₙ are equal in length; the rectangular correction plate ABCD is arranged in a scanning imaging system for line scanning, so that a scan image A′B′C′D′ of the rectangular correction plate is obtained.

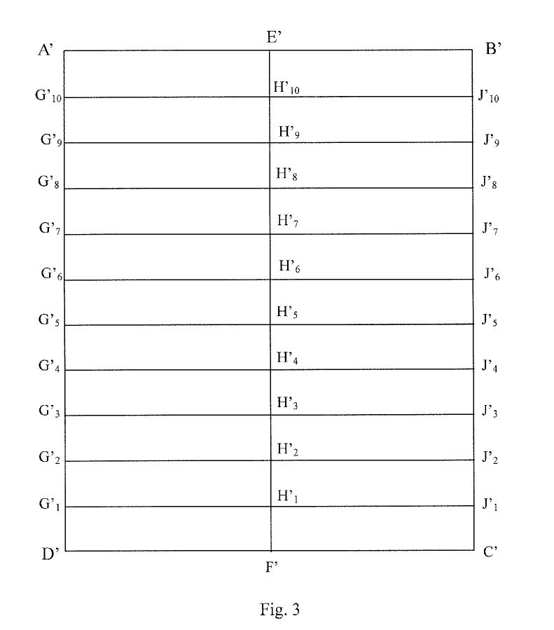

The second step of performing data processing for the scan image A′B′C′D′ is characterized in that: E′, F′, G′₁, G′₂, . . . , G′₉, G′₁₀, J′₁, J′₂, . . . , J′₉, J′₁₀, H′₁, H′₂, . . . , H′₉, and H′₁₀ are the images of E, F, G₁, G₂, . . . , G₉, G₁₀, J₁, J₂, . . . , J₉, J₁₀, H₁, H₂, . . . , H₉, and H₁₀, which are on the correction plate ABCD, in the scan image A′B′C′D′, respectively, as shown in FIG. 3; the lengths of the line segments H′₁H′₂, H′₂H′₃, . . . , H′₈H′₉, and H′₉H′₁₀ in the scan image A′B′C′D′ of the correction plate are obtained through calculation, i.e., L_{H′1H′2}=100, L_{H′2H′3}=99, L_{H′3H′4}=100, L_{H′4H′5}=98, L_{H′5H′6}=101, L_{H′6H′7}=100, L_{H′7H′8}=99, L_{H′8H′9}=100 and L_{H′9H′10}=102;

The third step of calculating a uniformity characterization value S of the movement speed of the scanned target is characterized in that: first, an average value L_{avg} of the lengths of the line segments H′₁H′₂, H′₂H′₃, . . . , H′ₙ₋₂H′ₙ₋₁, and H′ₙ₋₁H′ₙ , is calculated, i.e.,

$${L}_{avg} = \frac{{\sum }_{i = 2}^{n} {L}_{{H}_{i - 1}^{′} {H}_{i}^{′}}}{n - 1} = 100 ;$$

then, a uniformity characterization value S of the movement speed of the scanned object is calculated, i.e.,

$$S = \sqrt{\frac{{\sum }_{i = 2}^{n} {( {L}_{{H}_{i - 1}^{′} {L}_{i}^{′}} - {L}_{avg} )}^{2}}{n - 2}} = 1.22 ;$$

the closer the value S is to zero, the better the uniformity of the movement speed of the scanned target is.

1. A method for detecting movement speed uniformity of a scanned target in a line scanning imaging process, comprising the following steps:
step 1) obtaining a scan image of a rectangular correction plate ABCD;
step 2) performing data processing for a scan image A′B′C′D′; and
step 3) calculating a uniformity characterization value S of the movement speed of the scanned target.

2. The method for detecting movement speed uniformity of a scanned target in a line scanning imaging process according to claim 1, wherein, the first step of obtaining a scan image of a rectangular correction plate ABCD is as follows:
a line segment EF is the-a line of left-right central symmetry of the rectangular correction plate ABCD, and line segments G₁J₁, G₂J₂, . . . , Gₙ₋₁, and GₙJₙ are perpendicular to the line segment EF respectively and intersect with the line segment EF at H₁, H₂, . . . , Hₙ₋₁, and Hₙ respectively; in addition, line segments H₁H₂, H₂H₃, . . . , Hₙ₋₂₂Hₙ₋₁, and Hₙ₋₁Hₙ are equal in length; the rectangular correction plate ABCD is arranged in a scanning imaging system for line scanning, so that a scan image A′B′C′D′ of the rectangular correction plate is obtained.

3. The method for detecting movement speed uniformity of a scanned target in a line scanning imaging process according to claim 1, wherein, the second step of performing data processing for the scan image A′B′C′D′ is as follows:
E′, F′, G′₁, G′₂, . . . , G′ₙ₋₁, G′ₙ , J′₁, J′₂, . . . , J′ₙ₋₁, J′ₙ, H′₁, H′₂, and H′ₙ₋₁, and H′ₙ are images of E, F, G₁, G₂, . . . , Gₙ₋₁, Gₙ, J₁, J₂, . . . , Jₙ₋₁, Jₙ, H₁, H₂, . . . , Hₙ₋₁, and Hₙ, which are on the correction plate ABCD, in the scan image A′B′C′D′, respectively; the lengths L_{H′1H′2}, L_{H′2H′3}, . . . , L_{H′n-2H′n-1}, and L_{H′n-1H′n} of the line segments H′₁H′₂, H′₂H′₃, . . . , H′ₙ₋₂H′n-1, and H′ₙ₋₁H′ₙ in the scan image A′B′C′D of the correction plate are extracted.

4. The method for detecting movement speed uniformity of a scanned target in a line scanning imaging process according to claim 1, wherein, the third step of calculating a uniformity characterization value S of the movement speed of the scanned target is as follows:
first, an average value L_{avg} of the lengths of the line segments H′₁H′₂, H′₂H′₃, . . . , H′ₙ₋₂H′ₙ₋₁ and H′ₙ₋₁H′ₙ is calculated with a calculation formula
$${L}_{avg} = \frac{{\sum }_{i = 2}^{n} {L}_{{H}_{i - 1}^{′} {H}_{i}^{′}}}{n - 1} ,$$
according to the lengths L_{H′1H′2}, L_{H′2H′3}, . . . , L_{H′n-2H′n-1}, and L_{H′n-1H′n} of the line segments H′₁H′₂H′₃, . . . , H′ₙ₋₂H′ₙ₋₁, and H′ₙ₋₁H′ₙ; then, a uniformity characterization value S of the movement speed of the scanned target is calculated, with a calculation formula
$$S = \sqrt{\frac{{\sum }_{i = 2}^{n} {( {L}_{{H}_{i - 1}^{′} {L}_{i}^{′}} - {L}_{avg} )}^{2}}{n - 2}} ,$$
wherein, the closer the value S is to zero, the better the uniformity of the movement speed of the scanned target.
